(19) United States
(12) Patent Application Publication
(10) Pub. No.: US 2023/0315426 A1
(43) Pub. Date: Oct. 5, 2023

(54) METHOD FOR UPDATING FIRMWARE, SECURITY DEVICE AND COMPUTER READABLE STORAGE MEDIUM

(71) Applicant: PAX COMPUTER TECHNOLOGY (SHENZHEN) CO., LTD., Shenzhen, Guangdong (CN)

(72) Inventors: Chuan LIU, Shenzhen, Guangdong (CN); Yanfei WANG, Shenzhen, Guangdong (CN)

(73) Assignee: PAX COMPUTER TECHNOLOGY (SHENZHEN) CO., LTD., Shenzhen, Guangdong (CN)

(21) Appl. No.: 18/044,634

(22) PCT Filed: Jul. 14, 2021
(86) PCT No.: PCT/CN2021/106161

§ 371 Date: Mar. 9, 2023

(30) Foreign Application Priority Data
Sep. 11, 2020 (CN) 202010951977.7

(51) Int. Cl. G06F 8/65

(52) U.S. Cl. CPC G06F 8/65

(57) ABSTRACT

A method for updating firmware is provided. The method includes: obtaining an AP firmware update file and a SP firmware update file set by the AP, the AP firmware update file and the SP firmware update file set are obtained by parsing a same system firmware update file that has been released, and the SP firmware update file set supports multiple different models of the SP; updating, by the AP, a system firmware of the AP according to the AP firmware update file, and sending a target firmware update file parsed from the SP firmware update file set to the SP; the target firmware update file supports the models of the SP; updating, by the SP, a system firmware of the SP according to the target firmware update file. According to the present application, a unified management of firmware versions is facilitated.

### CROSS-REFERENCE TO RELATED APPLICATIONS

The present application is a 35 U.S.C. § 371 national stage application of PCT patent application No. PCT/CN2021/106161, filed on Jul. 14, 2021, which claims priority to Chinese patent application No. 202010951977.7, filed on Sep. 11, 2020. The entire contents of which are incorporated herein by reference.

### TECHNICAL FIELD

The present application relates to the field of computer technologies, and more particularly, to a method for updating firmware, a security device and a computer-readable storage medium.

### BACKGROUND

With rapid development of payment technologies, payment terminals, such as a point of sale (Point of Sale, POS) machines, are becoming more and more popular. In order to ensure security of the payment terminal, the payment terminal having a single processor is gradually transitioned to the payment terminal having a dual processor which may specifically include an application processor (Application Processor, AP) and a security processor (Security Processor, SP). The SP is mainly responsible for the security of software and hardware of the payment terminal, and operates a single-task real-time operating system, has a relatively weaker operational performance. The AP is a main processor of the payment terminal, operates an operating system such as Linux or Android, and has higher operational performance.

When the payment terminal is developed, based on the consideration of cost, performance, etc., one AP may be utilized to operate the operating system and the applications. Then, based on the AP, different types of security processors (SPs) are used in cooperation with the AP, such that different payment terminals can be designed to meet different application scenarios. Currently, when the system firmware of the AP and the system firmware of the SPs in the payment terminal are updated, firmware update files for different combinations of the AP and the SPs may be packaged according to different combinations of the AP and the SPs when the firmware version is released.

### SUMMARY

In particular, for an AP, a first update file for updating a system firmware of the AP is generated. For multiple different models of SPs matching with the AP, second update files for updating the system firmware of various models of the SPs are generated, so that a plurality of second update files are obtained. Then, the first update file and the plurality of second update files are packaged, and a plurality of firmware update files are obtained and released. Each firmware update file includes one first update file and one second update file. The payment terminal obtains a firmware update file applicable to the AP and the SP thereof from the plurality of firmware update files to update the system firmware. In this condition, it is quite inconvenient to publish and manage the firmware update files.

A method for updating firmware, a security device and a computer-readable storage medium are provided in the present application, so that a unified management of the firmware versions may be facilitated.

In the first aspect, a method for firmware update is provided, the method is applied to a first device including an application processor (AP) and a security processor (SP), the method includes:

by the AP, obtaining an AP firmware update file and a SP firmware update file set by the AP; the AP firmware update file and the SP firmware update file set are obtained by parsing a same system firmware update file that has been released, and the SP firmware update file set supports multiple different models of the SP;

by the AP, updating a system firmware of the AP according to the AP firmware update file and sending a target firmware update file parsed from the SP firmware update file set to the SP; the target firmware update file supports the multiple different models of the SP; and

by the SP, updating a system firmware of the SP according to the target firmware update file.

In the present application, the AP in the first device obtains the AP firmware update file and the SP firmware update file set. The AP updates the system firmware of the AP according to the AP firmware update file, and sends the target firmware update file, which is parsed from the SP firmware update file set and supports the model of the SP in the first device, to the SP. The SP updates the system firmware of the SP according to the target firmware update file. The AP firmware update file and the SP firmware update file set are obtained by parsing a same system firmware update file that has been released, and the SP firmware update file set supports multiple different SP models. That is, in this embodiment of the present application, the unified system firmware update file may be used to update the system firmware of the AP and the system firmware of the SP of different models. Thus, when the firmware version is released, there is no need to release different firmware update files for different models of SPs; instead, it only needs to release the unified system firmware update file. Thus, the releasing of the firmware version that is irrelevant to the SP models is realized, so that a unified management of firmware versions is facilitated.

In one embodiment, said by the AP, obtaining the AP firmware update file and the SP firmware update file set includes:

receiving, by the AP, the AP firmware update file and the SP firmware update file set sent by a second device, wherein after the second device obtains the system firmware update file from a firmware releasing platform, the AP firmware update file and the SP firmware update file set are obtained by the second device by parsing the system firmware update file; or

receiving, by the AP, the system firmware update file sent by the second device, and parsing the system firmware update file to obtain the AP firmware update file and the SP firmware update file set; the system firmware update file is obtained by the second device from a firmware releasing platform.

In one embodiment, said by the AP, sending the target firmware update file parsed from the SP firmware update file set to the SP includes:

sending, by the AP, a model acquisition request to the SP;

sending, by the SP, a model of the SP to the AP, after receiving the model acquisition request from the AP;

parsing out, by the AP, the target firmware update file supporting the model of the SP from the SP firmware update file set after receiving the model of the SP;

sending, by the AP, the target firmware update file to the SP.

In one embodiment, said parsing out, by the AP, the target firmware update file supporting the model of the SP from the SP firmware update file set includes:

obtaining, by the AP, a file name label corresponding to the model of the SP from a stored correspondence relationship between SP models and file name labels, and taking the obtained file name label as a first label;

parsing out, by the AP, a file name containing the first label and a file location corresponding to the file name from a source file directory area of the SP firmware update file set;

parsing out, by the AP, a firmware update file from a source file data area of the SP firmware update file set according to the file location corresponding to the file name and taking the parsed firm update file as the target firmware update file.

In one embodiment, said parsing out, by the AP, the target firmware update file supporting the model of the SP from the SP firmware update file set includes:

obtaining, by the AP, a file header label corresponding to the model of the SP from a stored correspondence relationship between SP models and file header labels, and taking the obtained file header label as a second label;

parsing out, by the AP, a firmware update file which has a file header containing the second label from a source file data area of the SP firmware update file set and taking the firmware update file as the target firmware update file.

In one embodiment, said parsing out, by the AP, the target firmware update file supporting the model of the SP from the SP firmware update file set includes:

obtaining, by the AP, a file location corresponding to the model of the SP from a stored correspondence relationship between SP models and file locations;

parsing out, by the AP, a firmware update file from a source file data area of the SP firmware update file set according to the obtained file location and taking the firmware update file as the target firmware update file.

In one embodiment, the first device is a payment terminal.

In a second aspect, a security device is provided, the security device includes an AP and a SP;

the AP is configured to obtain an AP firmware update file and an SP firmware update file set; wherein the AP firmware update file and the SP firmware update file set are obtained by parsing a same system firmware update file that has been released, and the SP firmware update file set supports multiple different models of the SP;

the AP is further configured to update a system firmware thereof according to the AP firmware update file, and send a target firmware update file parsed from the SP firmware update file set to the SP; wherein the target firmware update file supports the multiple different models of the SP;

the SP is configured to update a system firmware thereof according to the target firmware update file.

In one embodiment, the AP is configured to:

receive the AP firmware update file and the SP firmware update file set sent by a second device; the AP firmware update file and the SP firmware update file set are obtained by parsing the system firmware update file after the second device obtains the system firmware update file from the firmware releasing platform; or

receive a system firmware update file sent by the second device, and parse out the system firmware update file to obtain the AP firmware update file and the SP firmware update file set. The system firmware update file is obtained by the second device from the firmware releasing platform.

In one embodiment,

The AP is configured to send a model acquisition request to the SP.

The SP is configured to send the model of the SP to the AP after receiving the model acquisition request.

The AP is further configured to parse out a target firmware update file supporting the model of the SP from the SP firmware update file set; and send the target firmware update file to the SP.

In one embodiment, the AP is configured to:

obtain a file name label corresponding to the model of the SP from the stored correspondence relationship between SP models and file name labels, and take the obtained file name label as a first label;

parse out a file name containing the first label and a file location corresponding to the file name from a source file directory area of the SP firmware update file set;

parse out a firmware update file from the source file data area of the SP firmware update file set according to the file location corresponding to the file name, and take the firmware update file as the target firmware update file.

In one embodiment, the AP is configured to:

obtain a file header label corresponding to the model of the SP from a stored correspondence relationship between SP models and file header labels and take the file header label as a second label;

parse out a firmware update file which has a file header containing the second label from the source file data area of the SP firmware update file set and take the firmware update file as the target firmware update file.

In one embodiment, the AP is configured to:

obtain a file location corresponding to the model of the SP from a stored correspondence relationship between SP models and file locations;

parse out a firmware update file from the source file data area of the SP firmware update file set according to the obtained file location and take the firmware update file as the target firmware update file.

In one embodiment, the security device is a payment terminal.

In the third aspect, a computer device is provided, the computer device includes a memory, a processor, and a computer program stored in the memory and executable by the processor. The processor is configured to, when executing the computer program, implement the method for updating firmware.

In the fourth aspect, a computer-readable storage medium is provided in one embodiment of the present application. The computer-readable storage medium stores a computer program, that, when executed by a processor of a computer device, causes the processor of the computer device to implement the method for updating firmware.

In the fifth aspect, a computer program product containing an instruction is provided. When the computer program product is executed on a computer device, the computer device is caused to perform the method for updating firmware.

It may be understood that, regarding the beneficial effects of the second aspect, the third aspect, the fourth aspect and the fifth aspect, reference can be made to the relevant descriptions in the first aspect, the beneficial effects of the second aspect, the third aspect, the fourth aspect and the fifth aspect are not repeatedly described herein.

### BRIEF DESCRIPTION OF THE DRAWINGS

In order to describe the technical solutions in the embodiments of the present application more clearly, a brief introduction regarding the accompanying drawings needed to be used for describing the embodiments is given below. It is obvious that, the accompanying drawings described below are only some embodiments of the present application. A person of ordinary skill in the art may also obtain other drawings according to the current drawings without paying creative efforts.

FIG. 1 illustrates a schematic flow diagram of a method for generating a firmware update file provided by one embodiment of the present application;

FIG. 2 illustrates a schematic diagram of a system firmware update file provided by one embodiment of the present application;

FIG. 3 illustrates schematic flow diagram of a method for updating firmware provided by one embodiment of the present application;

FIG. 4 illustrates schematic structural diagram of a security device provided by one embodiment of the present application; and

FIG. 5 illustrates a schematic structural diagram of a computer device provided by one embodiment of the present application.

### DETAILED DESCRIPTION OF EMBODIMENTS

In order to make the objective, the technical solutions and the advantages of the present application be clearer, the technical solutions of the embodiments of the present application will be further described in detail with reference to the accompanying figures.

It should be understood that the term of “a plurality of” used in the present application refers to two or more than two. In the descriptions of the present application, “I” has the meaning of or unless otherwise there is definition of “/”. For example, AB may represent A or B. The phrase of “and/or” in the present application is merely an association relationship for describing associated objects, and indicates that three relationships may exist. For example, A and/or B may represent that A exists alone, A and B exist at the same time, and B exists alone. In addition, in order to facilitate clearly describing the technical solutions of the present application, terms such as “first” and “second” are used to distinguish the same items or similar items having the same function and effect. Those skilled in the art may understand that terms such as “first” and “second” are not intended to limit the number and the order of execution. Moreover, and the terms such as “first” and “second” do not means that there must be a difference.

Before explaining and describing the embodiments of the present application in detail, the application scenario of the embodiments of the present application is described first.

With rapid development of payment technology, payment terminals such as point of sale (Point of Sale, POS) machines are becoming more and more popular. A payment terminal may include an application processor (Application Processor, AP) and a security processor (Security Processor, SP). The SP is mainly responsible for the security of software and hardware of the payment terminal, and needs to be authenticated by payment card industry (Payment Card Industry, PCI) PIN transaction security (PIN Transaction Security, PTS). In order to save costs, a processor having a weak operational performance is generally used as the SP to operate a single-task real-time operating system. The AP is a main processor of the payment terminal, operates an operating system such as Linux or Android, and does not need to be authenticated by PCI PTS. In order to improve the experience of the operating system and the applications, the AP is generally provided with higher operational performance.

When the payment terminal is developed, based on the consideration of cost, performance, etc., an AP may be used to operate the operating system and the applications. Then, different models of security processors (SPs) are used in cooperation with the AP accordingly, so that different payment terminals can be designed to meet different application scenarios. For one example, the AP may operate in cooperation with a SP having few resources to meet a requirement of a mini POS machine having a relatively simple function. The SP of this model may be connected to a contact integrated circuit (Integrated Circuit, IC) card and a contactless IC card. However, the SP cannot be connected to a printer and a magnetic head. For another example, the AP may operate in cooperation with more SPs to satisfy a desktop POS machine, and the SP of this model may be connected to the contact IC card, the contactless IC card, the printer, and the magnetic head.

In the related art, when the system firmware of the AP and the system firmware of the SP in the payment terminal are updated, firmware update files for different combinations of AP and SPs can be packaged according to the different combinations of AP and SPs when the firmware version is released. For example, when the system firmware is updated, for an AP, there is an update file A suitable for the AP, and there is an update file B1 for a first SP adapted to the AP, and there is an update file B2 of a second SP adapted to the AP. When the firmware version is released, a firmware update file which is obtained by packaging the update file A and the update file B1 or a firmware update file which is obtained by packaging the update file A and the update file B2 are selectively released according to different payment terminals. However, much inconvenience is brought to unified management of firmware versions due to the adoption of the aforesaid approach for updating system firmware.

In order to solve the aforesaid technical problem, embodiments of the present application provide a method for updating firmware, which may use a unified system firmware update file to update the system firmware of the AP and the SPs of different models. An effect of using the same system firmware update file to update the system firmware regardless of the models of the SPs operating in cooperation with the AP is achieved as long as the used AP is the same. Thus, when the firmware version is released, there is no need to publish different firmware update files for different SP models. Instead, it only needs to publish the unified system firmware update file. Thus, the releasing of the firmware version that is irrelevant to the SP models is realized, and a unified management of firmware versions is facilitated.

Next, a process of generating the firmware update file is described in detail.

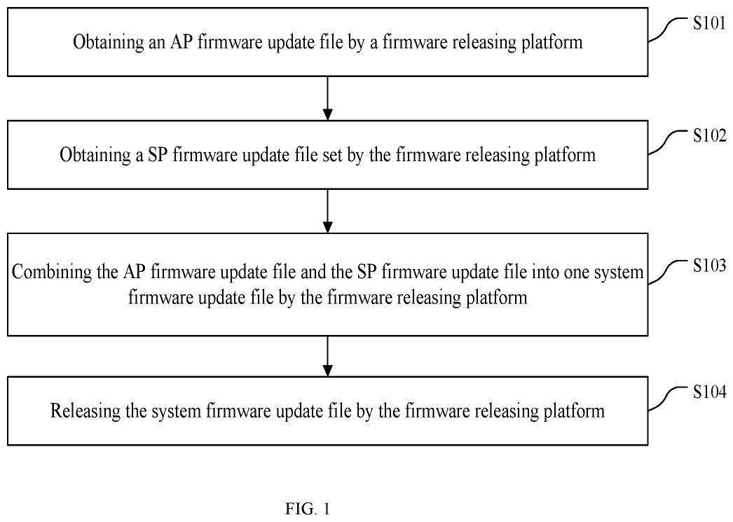

FIG. 1 illustrates a flow diagram of a method for generating a firmware update file according to one embodiment of the present application. Referring to FIG. 1, this method includes the following steps:

In a step of S101, an AP firmware update file is obtained from a firmware releasing platform.

The AP firmware update file is used to update the system firmware of the AP.

In particular, the firmware releasing platform may compile and package source codes of the system firmware for updating the AP to obtain the AP firmware update file for updating the system firmware of the AP.

For example, the firmware releasing platform may compile and package the AP firmware update file for updating the system firmware of the AP. The AP firmware update file may be referred to as an update file A.

In a step of S102, a SP firmware update file set is obtained by the firmware releasing platform.

The SP firmware update file set supports multiple different models of SPs. The SP firmware update file set may be obtained by packaging a plurality of firmware update files in a certain organization form, that is, the SP firmware update file set may be a compressed package (including but not limited to a compressed file format such as ZIP, RAR, etc.). The plurality of firmware update files are in one-to-one correspondence with the multiple different SP models, and each of the plurality of firmware update files is used for updating a system firmware of a SP having a SP model corresponding to the firmware update file. The different SP models are the models of all SPs that can be used in cooperation with the AP.

In particular, for any one of the different SP models, the firmware releasing platform may compile and package the source codes of the system firmware for updating the SPs having the SP models to obtain firmware update files of the system firmware for updating the SPs having the SP models. Then, the firmware releasing platform may package the plurality of obtained firmware update files into one integral SP firmware update file set.

For example, the multiple different SP models include model 1, model 2, model 3, . . . , a model N. The firmware releasing platform may compile and package a firmware update file for updating the system firmware of a SP of the model 1, and this firmware update file may be referred to as an update file B1. The firmware releasing platform may compile and package a firmware update file for updating system firmware of a SP of model 2, and this firmware update file may be referred to as update file B2, and so on. This firmware releasing platform may compile and package N firmware update files. Then, the firmware releasing platform may package the N firmware update files into one integral SP firmware update file set which may be referred to as an update file set B.

In a step of S103, the AP firmware update file and the SP firmware update file set are combined into one system firmware update file by the firmware releasing platform.

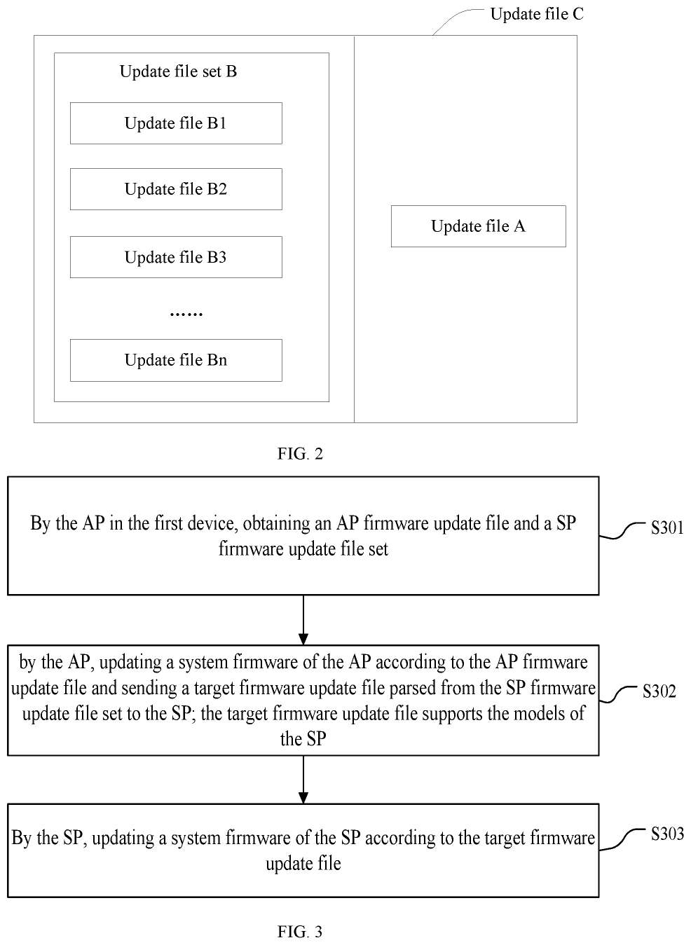

For example, the firmware releasing platform may combine the update file A and the update file set B into the system firmware update file. The system firmware update file may be referred to as an update file C which may be as shown in FIG. 2.

In a step of S104, the system firmware update file is released by the firmware releasing platform.

In this embodiment of the present application, with regard to the condition of one AP that operates with SPs of multiple different models, the AP firmware update file corresponding to the AP may be generated first, then, the SP firmware update file set corresponding to the multiple different models of SPs is generated, then, the AP firmware update file and the SP firmware update file set are combined into one system firmware update file to be released.

In this condition, the system firmware update file released by the firmware releasing platform includes firmware update files of AP firmware update file and the SP firmware update file. The AP firmware update file is used for updating the system firmware of the AP. For example, the AP firmware update file may be the aforesaid update file A. The SP firmware update files are a set of SP firmware update files suitable for all different models of SPs matching with the AP. For example, the SP firmware update files may be the aforesaid update file set B, and the update file set B is the combination of the update file B1, the update file B2, . . . , the update file Bn.

In this embodiment of the present application, the overall organization structure of the system firmware update file is the same as that of the existing technology, both of them use an organization mode of using the combination of the AP firmware update file and the SP firmware update files. Thus, the system firmware update file may be compatible with the existing download tools (including but is not limited to a production tool, a customer development tool, a maintenance tool, etc.). In this way, when a file is downloaded, the download tool may still use the existing download method to obtain the system firmware update file.

A process of using the aforesaid system firmware update file to update firmware is described in detail below.

FIG. 3 illustrates a flow diagram of method for updating firmware according to one embodiment of the present application. Referring to FIG. 3, this method is applied to a first device which includes an application processor (Application Processor, AP) and a security processor (Security Processor, SP). The method includes the steps listed below:

In a step of S301, an AP firmware update file and a SP firmware update file set are obtained by the AP in the first device.

The AP firmware update file is the AP firmware update file described in the embodiment of FIG. 1. The SP firmware update file set is the SP firmware update file set described in the embodiment of FIG. 1. That is, the AP firmware update file and the SP firmware update file set are obtained by parsing a same system firmware update file that has been released (i.e., the system firmware update file in the embodiment of FIG. 1). The SP firmware update file set supports multiple different SP models.

In particular, there are various approaches for obtaining the AP firmware update file and the SP firmware update file set by the AP, two possible approaches are described below:

With regard to a first possible approach, the AP receives the AP firmware update file and the SP firmware update file set sent by a second device.

The AP firmware update file and the SP firmware update file set are obtained by the second device by parsing the system firmware update file after the system firmware update file is obtained by the second device from the firmware releasing platform.

After the firmware releasing platform releases the system firmware update file, the second device may obtain the system firmware update file from the firmware releasing platform, parse the system firmware update file to obtain the AP firmware update file and the SP firmware update file set, and then send the AP firmware update file and the SP firmware update file set to the first device.

With regard to a second possible approach, the AP receives the system firmware update file sent by the second device, and parses the system firmware update file to obtain the AP firmware update file and the SP firmware update file set.

The system firmware update file is obtained by the second device from the firmware releasing platform.

After the firmware releasing platform releases the system firmware update file, the second device may obtain the system firmware update file from the firmware releasing platform and send the system firmware update file to the first device.

The first device may be a payment terminal, such as a POS machine. The second device may be a device installed with a download tool and being capable of obtaining the system firmware update file from the firmware releasing platform. For example, the second device may be a personal computer, a mobile phone, a personal digital assistant (Personal Digital Assistant, PDA), a tablet computer, or the like.

The first device and the second device may be communicated through a wired connection or a wireless connection. In this way, the second device may send the AP firmware update file and the SP firmware update file set to the AP in the first device, or send the system firmware update file to the AP in the first device.

In a step of S302, the AP updates the system firmware of the AP according to the AP firmware update file, and sends a target firmware update file parsed from the SP firmware update file set to the SP in the first device. The target firmware update file supports the models of the SP.

The operation of updating the system firmware of the AP by the AP according to the AP firmware update file is similar to the self-updating operation of the system firmware according to the firmware update file in the related art, and thus is not repeatedly described in detail herein.

The SP firmware update file set may support multiple different SP models. Therefore, the AP may parse the target firmware update file supporting the model of the SP from the SP firmware update file set and send the target firmware update file to the SP, so that the SP may update its own system firmware accordingly.

The operation of sending the target firmware update file parsed from the SP firmware update file set to the SP by the AP may be implemented as: the AP sends a model acquisition request to the SP; after receiving the model acquisition request, the SP sends the model of the SP to the AP; the AP parses out a target firmware update file supporting the model of the SP from the SP firmware update file set after receiving the model of the SP; the AP sends the target firmware update file to the SP.

The AP may communicate with the SP. For example, the AP and the SP may be communicated based on a communication protocol such as a serial peripheral interface (Serial Peripheral Interface, SPI) bus protocol, a serial communication protocol, and the like. The communication protocol is not solely limited in this embodiment of the present application. In this way, the AP may send the model acquisition request to the SP and send the target firmware update file to the SP. The SP may also send the model thereof to the AP.

The model acquisition request is used to request for acquiring the model of the SP. After receiving the model acquisition request sent by the AP, the SP may return the model of the SP to the AP in responsive to the model acquisition request.

There are various methods for parsing out the target firmware update file supporting the model of the SP from the SP firmware update file set by the AP. Three possible methods are described below.

In a first possible method, the AP obtains a file name label corresponding to the model of the SP as a first label from a stored correspondence between SP models and file name labels. The AP parses a file name including a first label and a file location corresponding to the file name from a source file directory area of the SP firmware update file set. The AP parses a firmware update file from the source file data area of the SP firmware update file set according to the file location corresponding to the file name, and takes the firmware update file as the target firmware update file.

The AP may pre-store a correspondence relationship between the SP models and file name labels. The file name label corresponding to the SP model in this correspondence relationship may indicate the file name of the firmware update file of the system firmware for updating the SP of the SP model. The file name label may be the same as the file name of the firmware update file; alternatively, the file name label may be a part of character strings of the file name of the firmware update file. Thus, after the AP obtains the first label corresponding to the model of the SP from this correspondence relationship, the target firmware update file may be parsed from the SP firmware update file set according to the first label.

For example, if the model of the SP is model 1, the AP may obtain the file name label, that is, label 1, corresponding to the model 1 from the correspondence relationship between SP models and file name labels shown in table 1, and takes the label 1 as the first label.

TABLE 1

| SP model | File name label |
|---|---|
| Model 1 | Label 1 |
| Model 2 | Label 2 |
| Model 3 | Label 3 |
| . . . | . . . |

In this embodiment of the present application, the correspondence relationship between the SP models and the file name labels are taken as example for illustration, and the embodiments of the present application are not limited by the table 1.

The SP firmware update file set may be composed of source file data area, source file directory area, and source file directory end flag. The source file directory area of the SP firmware update file set includes the attributes of multiple firmware update files (including but not limited to file name, file location, etc.). The source file data area of the SP firmware update file set includes the multiple firmware update files. Each firmware update file in the multiple firmware update files includes a file header, file data, and data descriptor.

After obtaining the first label, the AP may parse the file name containing the first label from the source file directory area of the SP firmware update file set, and parse the file location corresponding to the file name. The file location is used to indicate a location of the firmware update file having this file name in the SP firmware update file set. After that, the AP may parse out a firmware update file located at the file location in the SP firmware update file set, and this firmware update file is the target firmware update file.

In the second possible method, the AP obtains a file header label corresponding to the SP model from the stored correspondence relationship between SP models and file header labels and takes the file header label as the second label. The AP parses a firmware update file which has a file header containing the second label from the source file data area of the SP firmware update file set and takes the firmware update file as the target firmware update file.

The AP may pre-store the correspondence relationship between SP models and file header labels. For any SP model in the correspondence relationship, the file header label corresponding to this SP model in the correspondence relationship may indicate the file header of the firmware update file used for updating the system firmware of the SP having the SP model. The file header label may be a part of character strings contained in the file header of the firmware update file. Therefore, after obtaining the second label corresponding to the model of the SP from the correspondence relationship, the AP may parse out the target firmware update file from the SP firmware update file set according to the second label.

For example, if the model of the SP is model 1, the AP may obtain a file header label of label 7 corresponding to the model 1 from the correspondence relationship between SP models and file header labels shown in table 2 below, and take the label 7 as the second label.

TABLE 2

| SP model | File header label |
|---|---|
| Model 1 | Label 7 |
| Model 2 | Label 8 |
| Model 3 | Label 9 |
| . . . | . . . |

This embodiment of the present application is only described by taking the correspondence relationship between SP models and file header labels shown in table 2 as an example. This embodiment of the present application is not limited by the table 2.

The SP firmware update file set may be composed of a source file data area, a source file directory area, and a source file directory end flag. The source file data area of the SP firmware update file set includes the plurality of firmware update files, and each of the plurality of firmware update files includes a file header, file data, and a data descriptor.

After obtaining the second tag, the AP may parse a firmware update file having a file header containing the second tag from the source file data area of the SP firmware update file set, and the firmware update file is the target firmware update file.

In the third possible method, the AP obtains the file location corresponding to the model of the SP from a stored correspondence relationship between SP models and file locations. The AP parses out a firmware update file from the source file data area of the SP firmware update file set according to the obtained file location and takes the firmware update file as the target firmware update file.

The AP may pre-store a correspondence relationship between SP models and file locations. For any SP model in this correspondence relationship, the file location corresponding to the SP model in this correspondence relationship may indicate the location where the firmware update file for updating the SP of the SP model is located in the SP firmware update file set. Thus, after obtaining the file location corresponding to the model of the SP from the correspondence relationship, a firmware update file located at the file location in the SP firmware update file set may be parsed, and the firmware update file is the target firmware update file.

For example, if the model of the SP is model 1, the AP may obtain the file location corresponding to the model 1 from the correspondence relationship between SP models and file locations as shown in table 3 below. Then, the AP may parse the target firmware update file located at the location 1 in the SP firmware update file set.

TABLE 3

| SP model | File location |
|---|---|
| Model 1 | Location 1 |
| Model 2 | Location 2 |
| Model 3 | Location 3 |
| . . . | . . . |

This embodiment of the present application is only described by taking the correspondence relationship between SP models and file locations shown in table 3 as an example. This embodiment of the present application is not limited by the table 3.

In addition to the three possible methods described above, the AP may also parse the target firmware update file supporting the model of the SP from the SP firmware update file set in other manners which are not solely limited in this embodiment of the present application.

In a step of S303, the system firmware of the SP is updated according to the target firmware update file.

The operation of updating the system firmware of the SP according to the target firmware update file is similar to the self-updating operation of the system firmware according to the firmware update file in the related art, and thus is not repeatedly described in detail herein.

In this embodiment of the present application, the AP in the first device obtains the AP firmware update file and the SP firmware update file set. The AP updates the system firmware of the AP according to the AP firmware update file, and sends the target firmware update file parsed from the SP firmware update file set and supporting the model of the SP in the first device to the SP. The SP updates the system firmware thereof according to the target firmware update file. The AP firmware update file and the SP firmware update file set are obtained by parsing a same system firmware update file that has been released, and the SP firmware update file set supports multiple different SP models. That is, in this embodiment of the present application, a unified system firmware update file may be used to update the system firmware of the AP and the system firmware the SP of different models. Thus, when a firmware version is released, there is no need to release different firmware update files for the SP of different models; instead, it only needs to release the unified system firmware update file. Thus, the releasing of the firmware version that is irrelevant to the SP models is realized, and a unified management of firmware versions is facilitated.

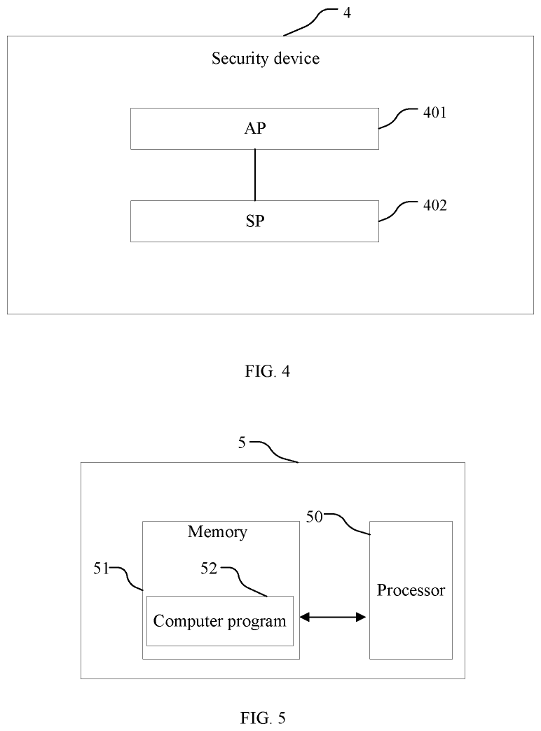

FIG. 4 illustrates a schematic structural diagram of a security device 4 according to one embodiment of the present application. Referring to FIG. 4, the security device 4 includes: an application processor (Application Processor, AP) 401 and a security processor (Security Processor, SP) 402.

The AP 401 is configured to obtain an AP firmware update file and a SP firmware update file set; the AP firmware update file and the SP firmware update file set are obtained by parsing a same system firmware update file that has been released. The SP firmware update file set supports multiple different SP models.

The AP 401 is further configured to update a system firmware of the AP 401 according to the AP firmware update file, and send a target firmware update file parsed from the SP firmware update file set to the SP 402. The target firmware update file supports models of the SP 402.

The SP 402 is configured to update a system firmware thereof according to the target firmware update file.

In one embodiment, the AP 401 is configured to:

receive the AP firmware update file and the SP firmware update file set sent by a second device; the AP firmware update file and the SP firmware update file set are obtained by parsing the system firmware update file after the second device obtains the system firmware update file from the firmware releasing platform; or

receive a system firmware update file sent by the second device, and parse out the system firmware update file to obtain the AP firmware update file and the SP firmware update file set. The system firmware update file is obtained by the second device from the firmware releasing platform.

In one embodiment,

The AP 401 is configured to send a model acquisition request to the SP 402.

The SP 402 is configured to send the model of the SP 402 to the AP 401 after receiving the model acquisition request.

The AP 401 is further configured to parse out a target firmware update file supporting the model of the SP 402 from the SP firmware update file set; and send the target firmware update file to the SP 402.

In one embodiment, the AP 401 is configured to:

obtain a file name label corresponding to the model of the SP 402 from the stored correspondence relationship between SP models and file name labels, and take the obtained file name label as a first label;

parse out a file name containing the first label and a file location corresponding to the file name from a source file directory area of the SP firmware update file set;

parse out a firmware update file from the source file data area of the SP firmware update file set according to the file location corresponding to the file name, and take the firmware update file as the target firmware update file.

In one embodiment, the AP 401 is configured to:

obtain a file header label corresponding to the model of the SP 402 from a stored correspondence relationship between SP models and file header labels and take the file header label as a second label;

parse out a firmware update file which has a file header containing the second label from the source file data area of the SP firmware update file set and take the firmware update file as the target firmware update file.

In one embodiment, the AP 401 is configured to:

obtain a file location corresponding to the model of the SP 402 from a stored correspondence relationship between SP models and file locations;

parse out a firmware update file from the source file data area of the SP firmware update file set according to the obtained file location and take the firmware update file as the target firmware update file.

In one embodiment, the security device 4 is a payment terminal.

In this embodiment of the present application, the AP 401 in the security device obtains the AP firmware update file and the SP firmware update file set. The AP 401 updates the system firmware of the AP according to the AP firmware update file, and sends the target firmware update file parsed from the SP firmware update file set and supporting the model of the SP in the security device 4 to the SP 401. The SP 401 updates the system firmware of the SP 401 according to the target firmware update file. The AP firmware update file and the SP firmware update file set are obtained by parsing a same system firmware update file that has been released, and the SP firmware update file set supports multiple different SP models. That is, in this embodiment of the present application, the unified system firmware update file may be used to update the system firmware of the AP 401 and the system firmware of the SP 402 of different models. Thus, when the firmware version is released, there is no need to release different firmware update files for the SP 402 of different models; instead, it only needs to release the unified system firmware update file. Thus, the releasing of the firmware version that is irrelevant to the SP models is realized, so that the unified management of firmware versions is facilitated.

It should be noted that, when the firmware of the security device provided in the aforesaid embodiment is updated, the firmware update of the security device is described by dividing of the aforesaid various functional modules as an example. In an actual application, the aforesaid functions may be assigned to different functional modules to be accomplished, that is, an inner structure of the device is divided into different functional modules to complete a whole or a part of functionalities described above. In addition, the embodiment of the security device and the embodiments of the firmware update method belong to the same concept. Regarding the specific implementation process of the security device, reference can be made to the details of the method embodiments, and the details of the specific implementation process of the security device are not repeatedly described herein.

FIG. 5 illustrates a schematic structural diagram of a computer device 5 provided by one embodiment of the present application. As shown in FIG. 5, the computer device 5 includes: a processor 50 (including but not limited to AP and SP), a memory 51 and a computer program 52 stored in the memory 51 and executable by the processor 50. When executing the computer program 52, the processor 50 is configured to implement the steps of the method for updating firmware in the embodiments described above.

The computer device 5 may be a payment terminal such as a POS machine. A person of ordinary skill in the art may understand that, FIG. 5 is only one example of the computer device 5, and thus should not be constituted as limitation to the computer device 5. More or less components than the components shown in FIG. 5 may be included. As an alternative, some components or different components may be combined. For example, the computer device 5 may also include an input and output device, a network access device, a bus, etc.

The processor 50 may be a central processing unit (Central Processing Unit, CPU), and may also be other general purpose processor, digital signal processor (Digital Signal Processor, DSP), application specific integrated circuit (Application Specific Integrated Circuit, ASIC), field-programmable gate array (Field-Programmable Gate Array, FGPA), or some other programmable logic devices, discrete gate or transistor logic device, discrete hardware component, etc. The general purpose processor may be a microprocessor. As an alternative, the processor may also be any conventional processor, or the like.

In some embodiments, the memory 51 may be an internal storage unit of the computer device 5, such as a hard disk or a memory of the computer device 5. In some other embodiments, the memory 51 may also be an external storage device of the computer device 5, such as a plug-in hard disk, a SMC (Smart Media Card), a SD (Secure Digital) card, a FC (Flash Card), a flash memory card equipped on the computer device 5. Furthermore, the memory 51 may not only include the internal storage unit of the computer device 5 but also include the external memory of the computer device 5. The memory 51 is configured to store operating system, application program, BootLoader, data and other program, such as procedure codes of a computer program. The memory 51 may also be configured to store data that has been output or being ready to be output temporarily.

In some embodiments, a computer-readable storage medium is further provided. The computer-readable storage medium stores a computer program. When the computer program is executed by a processor, the steps of the method for updating firmware in the aforesaid embodiments are implemented. For example, the computer-readable storage medium may be read-only memory (Read-Only Memory, ROM), a random access memory (Random Access Memory, RAM), compact disc read-only memory (Compact Disc Read-Only Memory, CD-ROM), magnetic tape, floppy disk, optical data storage device, etc.

It is worth noting that, the computer-readable storage medium mentioned in the present application may be a non-volatile storage medium, in other words, the computer-readable storage medium may be a non-transitory storage medium.

It should be understood that all or a part of the steps for realizing the aforesaid embodiments may be realized by software, hardware, firmware or any combination thereof. When the steps are implemented by software, the steps may be implemented in whole or in part in a form of computer program products. The computer program product includes one or more computer instructions. The computer instructions may be stored in the computer-readable storage medium.

In other words, in some embodiments, a computer program product containing an instruction is provided, when the computer program product is executed on a computer, the computer is caused to perform the steps of the method for updating firmware in the embodiments described above.

Only some optional embodiments of the present application have been described above, and these embodiments are not intended to limit the present application. Any modification, equivalent replacement, improvement, and the like, which are made within the spirit and the principle of the present application, should all be included in the protection scope of the present application.

1. A method for updating firmware, applied to a first device comprising an application processor (AP) and a security processor (SP), the method comprising:
by the AP, obtaining an AP firmware update file and a SP firmware update file set by the AP, wherein the AP firmware update file and the SP firmware update file set are obtained by parsing a same system firmware update file that has been released, and the SP firmware update file set supports multiple different models of the SP;
by the AP, updating a system firmware of the AP according to the AP firmware update file and sending a target firmware update file parsed from the SP firmware update file set to the SP; wherein the target firmware update file supports the multiple different models of the SP; and
by the SP, updating a system firmware of the SP according to the target firmware update file.

2. The method according to claim 1, wherein said by the AP, obtaining the AP firmware update file and the SP firmware update file set comprises:
receiving, by the AP, the AP firmware update file and the SP firmware update file set sent by a second device, wherein after the second device obtains the system firmware update file from a firmware releasing platform, the AP firmware update file and the SP firmware update file set are obtained by the second device by parsing the system firmware update file; or
receiving, by the AP, the system firmware update file sent by the second device, and parsing the system firmware update file to obtain the AP firmware update file and the SP firmware update file set; wherein the system firmware update file is obtained by the second device from a firmware releasing platform.

3. The method according to claim 1, wherein said by the AP, sending the target firmware update file parsed from the SP firmware update file set to the SP comprises:
sending, by the AP, a model acquisition request to the SP;
sending, by the SP, a model of the SP to the AP, after receiving the model acquisition request from the AP;
parsing out, by the AP, the target firmware update file supporting the model of the SP from the SP firmware update file set after receiving the model of the SP;
sending, by the AP, the target firmware update file to the SP.

4. The method according to claim 3, wherein said parsing out, by the AP, the target firmware update file supporting the model of the SP from the SP firmware update file set comprises:
obtaining, by the AP, a file name label corresponding to the model of the SP from a stored correspondence relationship between SP models and file name labels, and taking the obtained file name label as a first label;
parsing out, by the AP, a file name containing the first label and a file location corresponding to the file name from a source file directory area of the SP firmware update file set;
parsing out, by the AP, a firmware update file from a source file data area of the SP firmware update file set according to the file location corresponding to the file name and taking the parsed firm update file as the target firmware update file.

5. The method according to claim 3, wherein said parsing out, by the AP, the target firmware update file supporting the model of the SP from the SP firmware update file set comprises:
obtaining, by the AP, a file header label corresponding to the model of the SP from a stored correspondence relationship between SP models and file header labels, and taking the obtained file header label as a second label;
parsing out, by the AP, a firmware update file which has a file header containing the second label from a source file data area of the SP firmware update file set and taking the firmware update file as the target firmware update file.

6. The method according to claim 3, wherein said parsing out, by the AP, the target firmware update file supporting the model of the SP from the SP firmware update file set comprises:
obtaining, by the AP, a file location corresponding to the model of the SP from a stored correspondence relationship between SP models and file locations;
parsing out, by the AP, a firmware update file from a source file data area of the SP firmware update file set according to the obtained file location corresponding to the model of the SP and taking the firmware update file as the target firmware update file.

7. The method according to claim 1, wherein the first device is a payment terminal.

8. A security device, comprising an application processor (AP) and a security processor (SP);
wherein the AP is configured to obtain an AP firmware update file and an SP firmware update file set; wherein the AP firmware update file and the SP firmware update file set are obtained by parsing a same system firmware update file that has been released, and the SP firmware update file set supports multiple different models of the SP;
the AP is further configured to update a system firmware thereof according to the AP firmware update file, and send a target firmware update file parsed from the SP firmware update file set to the SP; wherein the target firmware update file supports the multiple different models of the SP;
the SP is configured to update the system firmware thereof according to the target firmware update file.

9. A terminal device, comprising a memory, a processor, and a computer program stored in the memory and executable by the processor, wherein, the processor is configured to, when executing the computer program, implement the method according to claim 1.

10. A non-transitory computer-readable storage medium, which stores a computer program, that, when executed by a processor of a terminal device, causes the processor of the terminal device to implement the method according to claim 1.

11. The security device according to claim 8, wherein the AP is configured to:
receive the AP firmware update file and the SP firmware update file set sent by a second device; the AP firmware update file and the SP firmware update file set are obtained by parsing the system firmware update file after the second device obtains the system firmware update file from the firmware releasing platform; or
receive a system firmware update file sent by the second device, and parse out the system firmware update file to obtain the AP firmware update file and the SP firmware update file set. The system firmware update file is obtained by the second device from the firmware releasing platform.

12. The security device according to claim 8, wherein the AP is further configured to send a model acquisition request to the SP;
the SP is further configured to send the model of the SP to the AP after receiving the model acquisition request;
the AP is further configured to parse out a target firmware update file supporting the model of the SP from the SP firmware update file set; and send the target firmware update file to the SP.

13. The security device according to claim 8, wherein the AP is further configured to:
obtain a file name label corresponding to the model of the SP from the stored correspondence relationship between SP models and file name labels, and take the obtained file name label as a first label;
parse out a file name containing the first label and a file location corresponding to the file name from a source file directory area of the SP firmware update file set;
parse out a firmware update file from the source file data area of the SP firmware update file set according to the file location corresponding to the file name, and take the firmware update file as the target firmware update file.

14. The security device according to claim 8, wherein the AP is further configured to:
obtain a file header label corresponding to the model of the SP from a stored correspondence relationship between SP models and file header labels and take the file header label as a second label;
parse out a firmware update file which has a file header containing the second label from the source file data area of the SP firmware update file set and take the firmware update file as the target firmware update file.

15. The security device according to claim 8, wherein the AP is further configured to
obtain a file location corresponding to the model of the SP from a stored correspondence relationship between SP models and file locations; and
parse out a firmware update file from the source file data area of the SP firmware update file set according to the obtained file location and take the firmware update file as the target firmware update file.

16. The security device according to claim 8, wherein the security device is a payment terminal.
